(19) United States
(12) Patent Application Publication
(10) Pub. No.: US 2004/0075062 A1
(43) Pub. Date: Apr. 22, 2004

(54) Stimulable phosphor sheet

(75) Inventors: Makoto Kashiwaya, Kanagawa (JP); Junji Nakada, Kanagawa (JP); Yasuo Iwabuchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/648,448

(22) Filed: Aug. 27, 2003

(30) Foreign Application Priority Data
Aug. 27, 2002 (JP) 2002-246628

(51) Int. Cl. G03B 42/08

(52) U.S. Cl. 250/484.4

(57) ABSTRACT

The stimulable phosphor sheet has a stimulable phosphor layer formed by a vacuum film forming technique. The stimulable phosphor layer contains a europium-activated cesium bromide based stimulable phosphor as a main ingredient. A maximum intensity of emission that is generated in a wavelength range of 490-510 nm when the stimulable phosphor layer is exposed to electron beams is lower than a maximum intensity of the emission generated in a wavelength range of 440-460 nm.

### BACKGROUND OF THE INVENTION

This invention relates to the field of stimulable phosphor sheet technology, more particularly, to a stimulable phosphor sheet that has a stimulable phosphor layer deposited by vacuum film formation and which exhibits satisfactory emission characteristics of accelerated phosphorescence (hereunder referred to simply as emission-upon-stimulation characteristics).

There are known a class of phosphors which accumulate a portion of applied radiations (e.g. x-rays, α-rays, β-rays, γ-rays, electron beams and uv(ultraviolet) radiation) and which, upon stimulation by exciting light such as visible light, give off a burst of light emission (extinction of accelerated phosphorescence) in proportion to the accumulated energy. Such phosphors called stimulable phosphors are employed in medical and various other applications.

An exemplary application is a radiation image information recording and reproducing system which employs a stimulable phosphor sheet having a layer formed of the stimulable phosphor. The layer is hereunder referred to as the phosphor layer and the stimulable phosphor sheet is hereunder referred to simply as a phosphor sheet or sometimes as a radiation image converting sheet. This radiation image information recording and reproducing system has already-been commercialized by various companies including Fuji Photo Film Co., Ltd. which has marketed FCR (Fuji Computed Radiography).

In that system, radiation image information about the subject such as the human body is recorded on the phosphor sheet (more specifically, the phosphor layer) and thereafter the phosphor sheet is scanned two-dimensionally with exciting light such as laser light to produce stimulated emission which, in turn, is read photoelectrically to yield an image signal and an image reproduced on the basis of the image signal is output as the radiation image of the subject, typically to a display device such as CRT or on a recording material such as a photographic material.

The phosphor sheet is typically produced by the steps of first preparing a paint having the particles of a stimulable phosphor dispersed in a solvent containing a binder, etc., applying the paint to a support in sheet form that is made of glass or resin, and drying the applied coating.

Phosphor sheets are also known that are made by forming a phosphor layer on a support through methods of physical vapor deposition (vapor-phase film formation) such as vacuum evaporation and sputtering (see, for example, JP 2789194 B and JP 5-249299 A). The phosphor layer prepared by evaporation has excellent characteristics. First, it contains less impurities since it is formed under vacuum; in addition, it is substantially free of any substances other than the stimulable phosphor, as exemplified by the binder, so it has high uniformity in performance and still assures very high luminous efficiency.

One of the most important characteristics required of the phosphor sheet may be the emission-upon-stimulation characteristic. When the phosphor layer is illuminated with x-rays (the energy of x-rays is accumulated) and later stimulated by exciting light such as laser light, the phosphor layer gives off light. The emission-upon-stimulation characteristic describes how much light is emitted relative to the exposure to x-rays.

Given the same levels for the exposure to x-rays and the intensity of the exciting light, the phosphor layer has a better emission-upon-stimulation characteristic if it emits a greater amount of light upon stimulation. Hence, a phosphor sheet having the phosphor layer with a good emission-upon-stimulation characteristic is a highly sensitive phosphor sheet that can produce adequate emission upon stimulation even when it was illuminated with a small dose of x-rays.

The process of taking an x-ray image using the phosphor sheet parallels imaging with an x-ray film in that the phosphor sheet is illuminated with x-rays through the subject, thereby taking an x-ray image on the phosphor sheet.

Therefore, the use of a highly sensitive phosphor sheet enables imaging at adequate intensity of x-rays even if it is illuminated with small quantities of x-rays. In other words, the exposure to x-rays is sufficiently lowered to reduce the burden on the subject.

### SUMMARY OF THE INVENTION

An object, therefore, of the present invention is to provide a stimulable phosphor sheet for use in the radiation image information recording and reproducing system and the like that has a stimulable phosphor layer exhibiting a satisfactory emission-upon-stimulation characteristic.

In order to attain the object described above, the present invention provides a stimulable phosphor sheet comprising: a stimulable phosphor layer containing a europium-activated cesium bromide based stimulable phosphor as a main ingredient, said stimulable phosphor layer being formed by a vacuum-film forming technique; and a substrate supporting said stimulable phosphor layer, wherein a maximum intensity of emission that is generated in a wavelength range of 490-510 nm when said stimulable phosphor layer is exposed to electron beams is lower than a maximum intensity of the emission generated in a wavelength range of 440-460 nm.

It is preferable that the stimulable phosphor sheet further comprises: a reflective film formed between said substrate and said stimulable phosphor layer, said reflective film for improving efficiency of emergence of stimulated light emission.

Preferably, said reflective film is a thin film made of one of Al, Al alloys, Ag and Ag alloys, and a film thickness of said reflective film ranges from 0.01 μm to 5 μm.

It is another preferable that the stimulable phosphor sheet further comprises: a barrier film formed between said reflective film and said stimulable phosphor layer, said barrier film for preventing said reflective film,

It is further preferable that the stimulable phosphor sheet further comprises: a barrier film formed on said stimulable phosphor layer, said barrier film for preventing said stimulable phosphor layer.

Preferably, said barrier film is a thin film made of one of silicon oxides, titanium oxides, silicon nitrides, cerium oxides and magnesium fluorides, and a film thickness of said barrier film ranges from 0.01 μm to 5 μm.

Preferably, said stimulable phosphor layer is a layer containing as said main ingredient a cesium bromide based stimulable phosphor using europium as an activator, and a molarity ratio between said activator and said cesium bromide based stimulable ranges from 0.0005:1 to 0.01:1.

Preferably, a film thickness of said stimulable phosphor layer ranges from 50 μm to 1000 μm.

Preferably, said maximum intensity of the emission generated in the wavelength range of 490-510 nm is equal to or lower than 70% of said maximum intensity of the emission generated in the wavelength range of 440-460 nm.

More preferably, said maximum intensity of the emission generated in the wavelength range of 490-510 nm is equal to or lower than 50% of said maximum intensity of the emission generated in the wavelength range of 440-460 nm.

In order to attain the object described above, the present invention provides a stimulable phosphor sheet comprising; a stimulable phosphor layer containing a europium-activated cesium bromide based stimulable phosphor as a main ingredient; and a substrate supporting said stimulable phosphor layer, wherein a maximum intensity of emission that is generated in a wavelength range of 490-510 nm when said stimulable phosphor layer is exposed to electron beams is lower than a maximum intensity of the emission generated in a wavelength range of 440-460 nm, and said stimulable phosphor layer is formed by a vacuum film forming technique comprising: a step of evaporating both of europium and cesium bromide by using a resistance heating in a film forming system; as well as a step of performing evaporation under an evaporation atmosphere in a range of 0.01-3 Pa to form said stimulable phosphor layer in said film forming system.

Preferably, said vacuum film forming technique further comprises: a step of heating said substrate during said evaporation; and a step of annealing said stimulable phosphor layer after it was formed on said substrate.

Preferably, a heating temperature for heating said substrate is in a range of 120-250° C. and a heating temperature for annealing said stimulable phosphor layer is in a range of 150-250° C.

### BRIEF DESCRIPTION OF THE DRAWING

FIG. 1 shows in conceptual form a stimulable phosphor sheet according to an embodiment of the invention.

### DETAILED DESCRIPTION OF THE INVENTION

On the pages that follow, the stimulable phosphor sheet of the invention is described in detail with reference to the preferred embodiment depicted in the accompanying drawing.

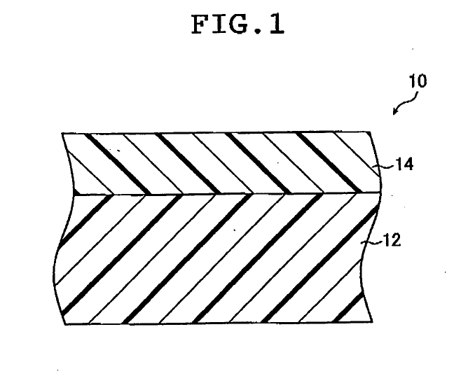

FIG. 1 shows in conceptual form an example of the stimulable phosphor sheet according to the invention.

The stimulable phosphor sheet generally indicated by 10 (which is hereunder referred to as phosphor sheet 10) consists basically of a substrate 12 having a stimulable phosphor layer 14 (hereunder a phosphor layer 14) formed on the surface by a vacuum film forming technique.

The illustrated phosphor sheet 10 has only the phosphor layer 14 on a surface of the substrate 12. This is not the sole case of the invention and various other designs can be adopted as long as the phosphor layer 14 has the characteristics described below.

For example, the phosphor layer 14 may be provided on top of a reflective film formed on a surface of the substrate 12 in order to improve the efficiency of emergence of stimulated light emission. Alternatively, a barrier-film for preventing the oxidation of the reflective film may be provided between the reflective film and the phosphor layer 14. If desired, the phosphor layer 14 may be overlaid with a barrier film for preventing oxidation of the phosphor layer 14, moisture adsorption into the phosphor layer 14 and the like.

The reflective film may be exemplified by thin (0.01-5 μm) films made of Al (aluminum), Ag (silver), Al alloys, Ag alloys, etc. The barrier film may be exemplified by thin (0.01-5 μm) films made of Si (silicon) oxides, Ti (titanium) oxides, Si nitrides, Si oxynitrides, Ce (cerium) oxides, Mg (magnesium) fluorides, etc.

These films may be formed by a variety of vacuum film forming techniques including sputtering and vacuum evaporation, from which a suitable one can be chosen depending upon the film to be formed.

Further referring to the phosphor sheet 10 of the invention, the substrate 12 is not limited to any particular types and all kinds of substrates in sheet form that are employed in phosphor sheets may be adopted, as exemplified by those which are made of glass, ceramics, carbon, aluminum, PET (polyethylene terephthalate), PEN (polyethylene naphthalate), polyimide, etc.

Speaking further of the phosphor sheet 10 of the invention, the phosphor layer 14 is a layer (film) that is formed by vacuum film forming techniques and which contains a stimulable phosphor as the main ingredient. It is a layer containing as the main ingredient a cesium bromide (CsBr) based stimulable phosphor using europium (Eu) as an activator, particularly, one that is represented by the general formula CsBr:Eu.

In the phosphor sheet 10 of the invention, the ratio between the phosphor and the activator in the phosphor layer 14 is not limited to any particular value and an appropriate value may be determined in accordance with the composition of the stimulable phosphor. The preferred range is from 0.0005:1 to 0.01:1 in terms of molarity ratio between the activator and the phosphor.

The thickness of the phosphor layer 14 also is not limited to any particular value and the thickness that can assure an adequate emission-upon-stimulation characteristic may be determined as appropriate for the composition of the phosphor layer 14. An advantageous range is from 50 to 1000 μm, with the range of 200-800 μm being particularly preferred.

The phosphor sheet 10 of the invention is characterized in that when the phosphor layer 14 is exposed to electron beams, a maximum intensity of the emission that occurs in the range of 490-510 nm is lower than a maximum intensity of the emission in the range of 440-460 nm.

Upon exposure to electron beams (e⁻), a variety of phosphors give off light at various wavelengths depending upon their composition, with the emission being called cathode luminescence or CL.

While the mechanism behind stimulated CL from the phosphor layer 14 (europium-activated alkali metal halide based, stimulable phosphor) formed by the vacuum film forming technique has not been fully unraveled, the present inventors found as the result of their intensive studies that the emission-upon-stimulation characteristic of the phosphor layer 14 can be improved by setting the CL's characteristic appropriately.

In the phosphor layer 14 in the phosphor sheet 10 of the invention, the CL's emission at 490-510=m and the emission at 440-460 nm are closely correlated to the emission-upon-stimulation characteristic and the phosphor layer 14 having a satisfactory emission-upon-stimulation characteristic can be obtained by ensuring that a maximum intensity of the CL's emission in the range of 490-510 nm is lower than a maximum intensity of the emission in the range of 440-460 nm.

The present invention has been accomplished on the basis of that finding and it realizes a phosphor sheet 10 having the phosphor layer 14 formed by the vacuum film forming technique, particularly a highly sensitive phosphor sheet 10 having excellent emission-upon-stimulation characteristics, by means of adjusting a maximum intensity of the CL's emission from the phosphor layer 14 at 490-510 nm to be lower than a maximum intensity of emission at 440-460 nm, preferably to 70% or less, more preferably to 50% or less, of the maximum intensity of emission at 440-460 nm.

Therefore, the phosphor sheet 10 of the invention as applied to measuring equipment for medical purposes such as the aforementioned FCR has the advantage of reducing the dose of exposure to x-rays and thus realizing a substantial decrease in the burden on the subject.

The method of CL measurement that can be used in the present invention is not limited in any particular way and commercial cathode luminescence spectroscopic devices may be employed.

Conditions for measurement including temperature and acceleration voltage are not limited in any particular way, either, and room temperature may be combined with appropriately set conditions that are suited to the cathode luminescence spectroscopic device used.

The method of forming the phosphor layer 14 in the phosphor sheet 10 of the invention is not limited in any particular way and various vacuum forming techniques can be employed, including sputtering, CVD and vacuum evaporation.

The film forming material is not limited in any particular way, either, and phosphor containing materials as well as activator containing materials (including the activator alone) may be chosen appropriately in accordance with the composition of the phosphor layer.

As already mentioned, the thickness of the phosphor layer 14 in the phosphor sheet 10 is preferably at least 50 μm, more preferably at least 200 μm, and it must be considerably thicker than those thin films which are formed by conventional vacuum film forming techniques. Hence, from productivity and other viewpoints, vacuum evaporation is preferably employed to form the phosphor layer 14.

As also mentioned above, the activator (e.g. europium) is contained in a much smaller amount than the phosphor. Therefore, in view of the composition and characteristics of the phosphor layer as exemplified by the precision in the addition of the activator and the state of its dispersion, binary or more complex vacuum evaporation is preferred, in which the activator containing material-and the phosphor containing material are heated to evaporate separately. Binary or more complex vacuum evaporation in which the activator containing material is evaporated by resistance heating and the phosphor containing material is evaporated by heating with electron beams is particularly preferred because the two kinds of material can be evaporated in close enough positions so that a phosphor layer excellent in characteristics such as the sharpness of a reproduced image can be formed at a satisfactorily high rate.

Another preferred film forming technique which is capable of forming a phosphor layer having excellent characteristics in such as emission-upon-stimulation and sharpness of an image comprises the steps of, in mono-vacuum evaporation, more preferably, in a binary or more complex evaporation, evacuating a film forming system so as to achieve the intermediate degree of vacuum in the range of about 0.01-3 Pa inside thereof, and performing resistance heating evaporation under the intermediate degree of vacuum to thereby form a phosphor layer by using a resistance heating as a means for heating all film forming materials. It is preferable that, in order to achieve the intermediate degree of vacuum in the range of about 0.01-3 Pa inside the film forming system, the-film forming technique first evacuates the film forming system to 1×10⁻³ Pa or below to achieve a high degree of vacuum, and second introduces an inert gas such as argon or nitrogen into the evacuated film forming system.

As already noted, a preferred phosphor is CsBr:Eu. In order to form the phosphor layer 14 of this composition, two film forming materials, cesium bromide (CsBr) and europium bromide (EuBrₓ, x being typically 2-3), are subjected to vacuum evaporation, the cesium bromide being evaporated by heating with electron beams and the europium bromide by resistance heating, or all film forming materials being heated by resistance heating to perform vacuum evaporation under the intermediate degree of vacuum so that the phosphor layer 14 comprising CsBr:Eu as the stimulable phosphor is formed on the substrate 12.

While any commercial europium bromide may be as the europium bromide which is one of the film forming materials, it is more preferable to use the europium bromide obtained by subjecting a commercial europium bromide to a melting process in a bromide gas such that the above-mentioned x is as close to 2 as possible.

The CL characteristics of the phosphor layer 14 to be formed can be controlled by adjusting the film forming conditions and performing post-treatments.

The CL characteristics of the phosphor layer to be formed may be controlled as appropriate for its composition and other relevant factors. For example, whichever film forming method is employed, the phosphor layer 14 having the desired CL characteristics is preferably formed as it is supplied with energy by heating the substrate, irradiating it with ions or otherwise treating it during film formation. It is also preferred to anneal (post-heat) the phosphor layer 14 after it was formed on the substrate.

The conditions for applying energy and annealing may be set as appropriate for the composition of the phosphor layer 14 to be formed, the film forming conditions, etc. For example, the heating temperature for heating the substrate during film formation is preferably set at or below 300° C., further, more preferably at or below 200° C.

In the case of evaporating both of europium and cesium bromide by using the resistance heating in the film forming system as well as performing the evaporation under the evaporation atmosphere of the intermediate degree of vacuum in the range of 0.01-3 Pa to form the stimulable phosphor layer in the film forming system, it is preferable that the heating of the substrate is performed during the evaporation and the annealing of the stimulable phosphor layer is performed after the evaporation.

In this case, it is more preferable that the heating temperature for heating the substrate is in the range of 120-250° C. and the heating temperature for annealing the stimulable phosphor layer is in the range of 150-250° C.

While the stimulable phosphor sheet of the invention has been described above in detail, the invention is not limited to the foregoing embodiment and various modifications and improvements can of course be made without departing from the spirit and scope of the invention.

The following example is provided for the purpose of further illustrating the present invention but should in no way to be taken as limiting.

### EXAMPLE 1

Using europium bromide as an activator's film forming material and cesium bromide as a phosphor's film forming material, binary vacuum evaporation was performed to prepare a phosphor sheet 10 as depicted in FIG. 1, with the CsBr:Eu phosphor layer 14 deposited on a surface of the glass substrate 12.

Europium bromide was heated with a resistance heater comprising a tantalum crucible and a 3-kW DC power supply. Cesium bromide was heated with electron beams from a 270° deflecting gun with a power of 10 kW.

The substrate 12 was set on a substrate holder in a vacuum chamber as an apparatus for vacuum evaporation. After setting the respective film forming materials in specified positions, the vacuum chamber was closed and evacuated using a diffusion pump and a cryogenic coil.

At the point in time when the degree of vacuum had reached 6×10⁻⁴ Pa, vacuum evaporation was started by heating the cesium bromide at an EB acceleration voltage of −4 kV and an emission current of 250 mA (equivalent to a deposition rate of about 200 nm/sec) and the europium bromide by resistance heating at a current of 150 A (equivalent to a deposition rate of about 1 nm/sec). As a result, the phosphor layer 14 (CsBr:Eu) was formed in a thickness of about 500 μm.

During the formation of the phosphor layer 14, the substrate holder was kept heated to heat the substrate 12.

By subsequent annealing in a nitrogen atmosphere for 2 hours, a phosphor sheet was completed.

The above-described procedure was repeated under various conditions for heating the substrate during film formation (not heated or heated at 100° C., 200° C. or 300° C.) and subsequent annealing (not annealed or annealed at 100° C., 200° C. or 300° C.), thereby preparing a total of 16 phosphor sheets.

Using a commercial CL (cathode luminescence) spectroscopic device having a 2-mm slit, the CL of each phosphor sheet was measured at an acceleration voltage of 10 kV and at room temperature. A maximum intensity of the emission at 490-510 nm was compared with a maximum intensity of the emission at 440-460 nm.

The results of comparison between maximum intensities of CL emission at the two tested wavelengths for the respective phosphor sheets are shown in Table 1 below.

The symbols in Table 1 mean the following: ⊚, a phosphor sheet showing a maximum intensity of CL emission at 490-510 nm which was not more than 50% of a maximum intensity of CL emission at 440-460 nm; ◯, a phosphor sheet showing a maximum intensity of CL emission at 490-510 nm which was more than 50% but not more than 70% of a maximum intensity of CL emission at 440-460 nm; Δ, a phosphor sheet showing a maximum intensity of CL emission at 490-510 nm which was more than 70% but not more than 90% of a maximum intensity of CL emission at 440-460 nm; X, a phosphor sheet showing a maximum intensity of CL emission at 490-510 nm which was more than 90% of a maximum intensity of CL emission at 440-460 nm.

TABLE 1

Substrate's heating temperature
during film formation

| | | None | 100° C. | 200° C. | 300° C. |
|---|---|---|---|---|---|
| Annealing | None | X | X | X | X |
| | 100° C. | X | X | Δ | X |
| | 200° C. | X | ◯ | ⊚ | ◯ |
| | 300° C. | X | X | Δ | X |

The phosphor sheets were then evaluated for their emission-upon-stimulation characteristics. As it turned out, the phosphor sheet rated ⊚ in Table 1 had excellent emission-upon-stimulation characteristics and the phosphor sheets rated ◯ had satisfactory emission-upon-stimulation characteristics. The emission-upon-stimulation characteristics of the phosphor sheets rated Δ in Table 1 were inferior to those of the phosphor sheets rated ◯ but had no problem for practical purposes. However, the emission-upon-stimulation characteristics of the phosphor sheets rated X in Table 1 were problematic for practical purposes.

The foregoing results clearly show the effectiveness of the present invention.

### EXAMPLE 2

Using europium bromide as an activator's film forming material and cesium bromide as a phosphor's film forming material, binary vacuum evaporation was performed to prepare a phosphor sheet 10 as depicted in FIG. 1, with the CsBr:Eu phosphor layer 14 deposited on a surface of the glass substrate 12.

These film forming materials were both heated with a resistance heater comprising a tantalum crucible and a 6-kW DC power supply.

The substrate 12 was set on a substrate holder in a vacuum chamber as an apparatus for vacuum evaporation. After setting the respective film forming materials in specified positions, the vacuum chamber was closed and evacuated using a diffusion pump and a cryogenic coil.

At the point in time when the degree of vacuum had reached 8×10⁻⁴ Pa, argon was introduced into the vacuum chamber to have the degree of vacuum of 0.5 Pa, and then the DC power supply was driven to electrify the crucibles filled with the film forming materials to thereby start the formation of the phosphor layer 14 (CsBr:Eu) on the surface of the substrate 12 by resistance heating.

It should be noted that the output of the DC power supply to both crucibles was adjusted so as to achieve 0.003:1 in terms of molarity ratio of Eu/Cs in the phosphor layer and to form the layer at the speed of 8 μm/mm.

During the formation of the phosphor layer 14, the surface (film forming surface) of the substrate 12 was directly heated with the halogen lamp.

At the point in time when the thickness of the phosphor layer 14 reached 600 μm, the film formation was terminated, and the phosphor sheet (the substrate 12 on which the phosphor layer 14 was formed) was taken out from the vacuum chamber.

By subsequent annealing in a nitrogen atmosphere for 2 hours, a phosphor sheet was completed.

The above-described procedure was repeated similarly under various conditions for heating the substrate during film formation (heated at 50° C., 80 ° C., 120° C., 180° C., or 250° C.) and subsequent annealing (not annealed or annealed at 150° C., 200° C. or 250° C.), thereby preparing a total of 20 phosphor sheets.

Using a commercial CL (cathode luminescence) spectroscopic device having a 500-μm slit, the CL of each phosphor sheet was measured at an acceleration voltage of 20 kV and at room temperature. A maximum intensity of the emission at 490-510 nm was compared with a maximum intensity of the emission at 440-460 nm.

The results of comparison between maximum intensities of CL emission at the two tested wavelengths for the respective phosphor sheets are shown in Table 2 below. The respective symbols of ⊚, ◯, Δ and X, in Table 2 mean the same as in aforementioned Table 1.

TABLE 2

| | | Substrate's heating temperature | | | | |
|---|---|---|---|---|---|---|
| | | during film formation | | | | |
| | | 50° C. | 80° C. | 120° C. | 180° C. | 250° C. |
| Annealing | None | X | X | X | X | X |
| | 150° C. | X | X | Δ | ◯ | Δ |
| | 200° C. | X | Δ | ◯ | ⊚ | ◯ |
| | 250° C. | X | X | Δ | Δ | Δ |

The phosphor sheets were similarly evaluated for their emission-upon-stimulation characteristics. Example 2 yielded the same results as in Example 1 for each of the phosphor sheets rated ⊚, ◯, Δ and X.

The foregoing results clearly show the effectiveness of the present invention.

As described above in detail, the stimulable phosphor sheet of the invention is adapted to satisfy a specified relation between wavelength-dependent maximum intensities of CE emission and, hence, it is a highly sensitive stimulable phosphor sheet having satisfactory emission-upon-stimulation characteristics. If the stimulable phosphor sheet of the invention is employed in a radiation image recording and reproducing system such as FCR, the dose of exposure to x-rays is sufficiently reduced to mitigate the burden on the subject.

What is claimed is:

1. A stimulable phosphor sheet comprising:
a stimulable phosphor layer containing a europium-activated cesium bromide based stimulable phosphor as a main ingredient, said stimulable phosphor layer being formed by a vacuum film forming technique; and
a substrate supporting said stimulable phosphor layer,
wherein a maximum intensity of emission that is generated in a wavelength range of 490-510 nm when said stimulable phosphor layer is exposed to electron beams is lower than a maximum intensity of the emission generated in a wavelength range of 440-460 nm.

2. The stimulable phosphor sheet according to claim 1, further comprising:
a reflective film formed between said substrate and said stimulable phosphor layer, said reflective film for improving efficiency of emergence of stimulated light emission.

3. The stimulable phosphor sheet according to claim 2, wherein said reflective film is a thin film made of one of Al, Al alloys, Ag and Ag alloys, and a film thickness of said reflective film ranges from 0.01 μm to 5 μm.

4. The stimulable phosphor sheet according to claim 2, further comprising:
a barrier film formed between said reflective film and said stimulable phosphor layer, said barrier film for preventing said reflective film.

5. The stimulable phosphor sheet according to claim 4, wherein said barrier film is a thin film made of one of silicon oxides, titanium oxides, silicon nitrides, cerium oxides and magnesium fluorides, and a film thickness of said barrier film ranges from 0.01 μm to 5 μm.

6. The stimulable phosphor sheet according to claim 1, further comprising:
a barrier film formed on said stimulable phosphor layer, said barrier film for preventing said stimulable phosphor layer.

7. The stimulable phosphor sheet according to claim 6, wherein said barrier film is a thin film made of one of silicon oxides, titanium oxides, silicon nitrides, silicon oxynitrides cerium oxides and magnesium fluorides, and a film thickness of said barrier film ranges from 0.01 μm to 5 μm.

8. The stimulable phosphor sheet according to claim 1, wherein said stimulable phosphor layer is a layer containing as said main ingredient a cesium bromide based stimulable phosphor using europium as an activator, and a molarity ratio between said activator and said cesium bromide based stimulable ranges from 0.0005:1 to 0.01:1.

9. The stimulable phosphor sheet according to claim 1, wherein a film thickness of said stimulable phosphor layer ranges from 50 μm to 1000 μm.

10. The stimulable phosphor sheet according to claim 1, wherein said maximum intensity of the emission generated in the wavelength range of 490-510 nm is equal to or lower than 70% of said maximum intensity of the emission generated in the wavelength range of 440-460 nm.

11. The stimulable phosphor sheet according to claim 1, wherein said maximum intensity of the emission generated in the wavelength range of 490-510 nm is equal to or lower than 50% of said maximum intensity of the emission generated in the wavelength range of 440-460 nm.

12. A stimulable phosphor sheet comprising:
a stimulable phosphor layer containing a europium-activated cesium bromide based stimulable phosphor as a main ingredient; and
a substrate supporting said stimulable phosphor layer,
wherein a maximum intensity of emission that is generated in a wavelength range of 490-510 nm when said stimulable phosphor layer is exposed to electron beams is lower than a maximum intensity of the emission generated in a wavelength range of 440-460 nm, and
said stimulable phosphor layer is formed by a vacuum film forming technique comprising:
a step of evaporating both of europium and cesium bromide by using a resistance heating in a film forming system; as well as
a step of performing evaporation under an evaporation atmosphere in a range of 0.01-3 Pa to form said stimulable phosphor layer in said film forming system.

13. The stimulable phosphor sheet according to claim 12, wherein said vacuum film forming technique further comprises:
a step of heating said substrate during said evaporation; and
a step of annealing said stimulable phosphor layer after it was formed on said substrate.

14. The stimulable phosphor sheet according to claim 13, wherein a heating temperature for heating said substrate is in a range of 120-250° C. and a heating temperature for annealing said stimulable phosphor layer is in a range of 150-250° C.
